(19) United States
(12) Patent Application Publication
(10) Pub. No.: US 2010/0118342 A1
(43) Pub. Date: May 13, 2010

(54) IMAGE FORMING APPARATUS AND PROGRAM

(75) Inventor: Aya Takio, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/615,147

(22) Filed: Nov. 9, 2009

(30) Foreign Application Priority Data
Nov. 10, 2008 (JP) 2008-28715

(51) Int. Cl. G06F 3/12

(52) U.S. Cl. 358/1.15; 358/1.16

(57) ABSTRACT

An image forming apparatus is connected to a memory unit in which a plurality of images is stored, forms an image which is selected by a user from the plurality of images and forms an index image in which a plurality of images which are not selected by the user is disposed. The image forming apparatus includes a group acquisition unit which acquires a group to which the plurality of image belongs from among a plurality of groups into which images are classified; a history registration unit which associates a formed image with the acquired group to be registered as an image forming history when an image selected by the user is formed; and an image forming unit which determines a group in which an image used in the index image is extracted, among the plurality of groups.

### BACKGROUND

1. Technical Field

The present invention relates to an image forming apparatus and program.

2. Related Art

Conventionally, as a kind of image forming apparatus, printers have been suggested which have an index printing function of reading an image shot by a digital camera and lining up and printing a plurality of images for a user to retrieve a desired image (for example, JP-A-2006-69012). This apparatus prints the information of the shooting date and time of each image within an index printing area together with each image, so that a user can easily perceive the shooting date of each image which is index-printed.

However, in the image forming apparatus described above, images can be disposed according to shooting date, but in order for a user to retrieve a desired image, all images with a corresponding date need to be retrieved. In recent years, as the capacity of memory cards for digital cameras increases, the number of images to be stored increases, and the number of images to be index-printed greatly increases. For this reason, when the shooting date is used as an index on its own, it may be difficult for a user to rapidly retrieve a desired image. For example, when a memory of a shooting date is vague, images of several days around a shooting date need to be retrieved, leading to a long retrieval time.

### SUMMARY

An advantage of some aspects of the invention is that it provides an image forming apparatus and program which improves the performance of image retrieval for an index image for a user.

The image forming apparatus and program of the invention employs the following means in order to achieve the above object.

According to an aspect of the invention, there is provided an image forming apparatus which is connected to a memory unit in which a plurality of images is stored, forms an image which is selected by a user from the plurality of images and forms an index image in which a plurality of images which are not selected by the user is disposed, the apparatus including: a group acquisition unit which acquires a group to which the plurality of image belongs to among a plurality of groups into which images are classified; a history registration unit which associates a formed image with the acquired group to be registered as an image forming history when an image selected by the user is formed; and an image forming unit which determines a group in which an image used in the index image is extracted, among the plurality of groups, based on the number of the formed images of respective groups which is registered as the image forming history, extracts an image from the determined group, and disposes the extracted image of each of the plurality of groups together to form the index image when forming of the index image is instructed.

According to the image forming apparatus of the invention, when forming of the index image is instructed, a group in which an image used in the index image is extracted is determined among the plurality of groups, based on the number of the formed images of respective groups which is registered as the image forming history, images are extracted from the determined group, and the extracted images of each of the plurality of groups are disposed together to form the index image. That is, the number of formed images of each group is reflected to extract an image used in the index image from each group. Since the formed image accompanies the selection of the user, an image used in the index image therefore reflects an image selection tendency of a user. The index image is commonly formed for the image retrieval, but since an image selection tendency of a user is reflected, an image which satisfies a user need is formed in the index image, whereby a user can easily retrieve an image. As a result, the performance of image retrieval can be improved for a user. Here, as a plurality of groups, for example, groups according to the shooting of scenes of respective images (a figure scene in which a figure is shot, a landscape scene in which a landscape is shot, and a night scene in which a night view is shot), groups of color tendencies of respective images, or groups of the time zones of the shooting of respective images may be included.

According to the image forming apparatus of the invention, the image forming unit may be a unit which determines the group which is largest in the number of the formed images as the group in which the image is extracted. Since the images which are most frequently selected by a user and have a high possibility to be selected by a user are formed in the index image, the image retrieval performance can be further improved. Further, according to the image forming apparatus, the image forming unit may be a unit which extracts an image from the determined group at a ratio which is approximately identical to a ratio of the numbers of formed images of the respective groups. Since more images are formed in the index image from a group in which more images are selected by a user, the image retrieval performance can be further improved. Alternatively, according to the image forming apparatus, the image forming unit may be a unit which extracts an image from the determined group at a rate which is approximately identical to a ratio of image forming rates of the respective groups in which the number of formed images of each group is divided by the number of image of each group. Even though the number of images selected by a user is small, since more images from a group which has a high rate of selection by a user in relation to the number of images of each group and thus has a high possibility of being selected later are formed in the index image, the image retrieval performance can be further improved.

Further, according to the image forming apparatus of the invention, the image forming unit may be a unit which extracts an image from the determined group excluding the formed image. Since there is a low possibility that an image already formed will be formed again, the image retrieval performance can be further improved by excluding an image for which there is not a great need.

Further, according to the image forming apparatus of the invention, the history registration unit may be a unit which registers an image processed by the user when an image is formed by multiplying the number of the formed images by a weighting coefficient of more than 1. Since a processed image which a user considers important is included in the image forming history, an image selection tendency can be more accurately reflected in the index image.

Further, according to the image forming apparatus of the invention, an image classification unit is further included which classifies the plurality of images into the plurality of groups, and the group acquisition unit may be a unit which acquires an image classification result from the image classification unit. Images which are not classified yet can be classified into groups.

According to another aspect of the invention, there is provided a program for operating a computer as the image forming apparatus described above. Therefore, the effects of the image forming apparatus of the invention such as the effect of improving the image retrieval performance of a user with regards to the index image can be provided. The program may be recorded on a computer readable record medium (for example, a hard disc, a programmable read only memory (ROM), a floppy disc (FD), a compact disc (CD), or a digital versatile disc (DVD)), may be transmitted from one computer to another computer via a transmission medium (a communication network such as the Internet or a local area network (LAN)), or may be exchanged in other forms.

### BRIEF DESCRIPTION OF THE DRAWINGS

The invention will be described with reference to the accompanying drawings, wherein like numbers reference like elements.

FIG. 1 is a configuration diagram illustrating a schematic configuration of a photo printer.

FIG. 2 is an explanation view illustrating an example of an image list.

FIG. 3 is a flowchart illustrating an example of a normal printing processing routine.

FIGS. 4A and 4B are explanation views illustrating an example of a printing image selection screen.

FIG. 5 is a flowchart illustrating an example of a printing history count processing routine.

FIG. 6 is a flowchart illustrating an example of an index printing processing routine.

FIG. 7 is an explanation view illustrating an example of an image printed through normal index printing.

FIG. 8 is an explanation view illustrating an example of an image printed through pick-up index printing.

FIG. 9 is an explanation view illustrating an example of an image printed through pick-up index printing.

### DESCRIPTION OF EXEMPLARY EMBODIMENTS

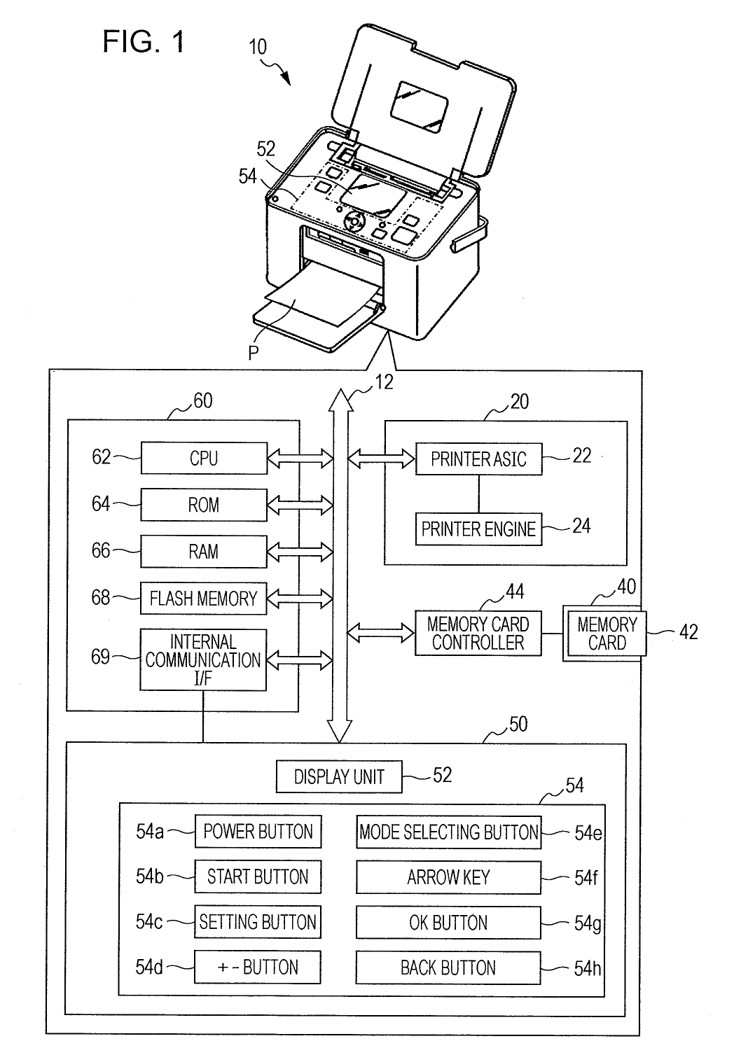

Hereinafter, embodiments of the invention will be described with reference to the accompanying drawings. FIG. 1 is an outline view and a block diagram illustrating a schematic configuration of a photo printer 10 which is an embodiment of an image forming apparatus of the invention.

The photo printer 10 according to the present embodiment includes a printer unit 20 which performs printing onto paper P, a memory card controller 44 which is in charge of data input/output from/to a memory card 42 mounted in a memory card slot 40, an operation panel 50 which displays various information through a display unit 52 or receives a user instruction through operation of a button set 54, and a main controller 60 which controls the whole apparatus as illustrated in FIG. 1. The photo printer 10 is configured such that the printer unit 20, the memory controller 44 and the main controller 60 exchange various control signals or data through a bus 12.

The printer unit 20 includes a printer ASIC 22 and a printer engine 24 which is configured in a well-known ink jet manner. The printer ASIC 22 is an integrated circuit which controls the printer engine 24. The printer ASIC 22 receives a printing instruction from the main controller 60 and controls the printer engine 24 to print a printing target image on paper P.

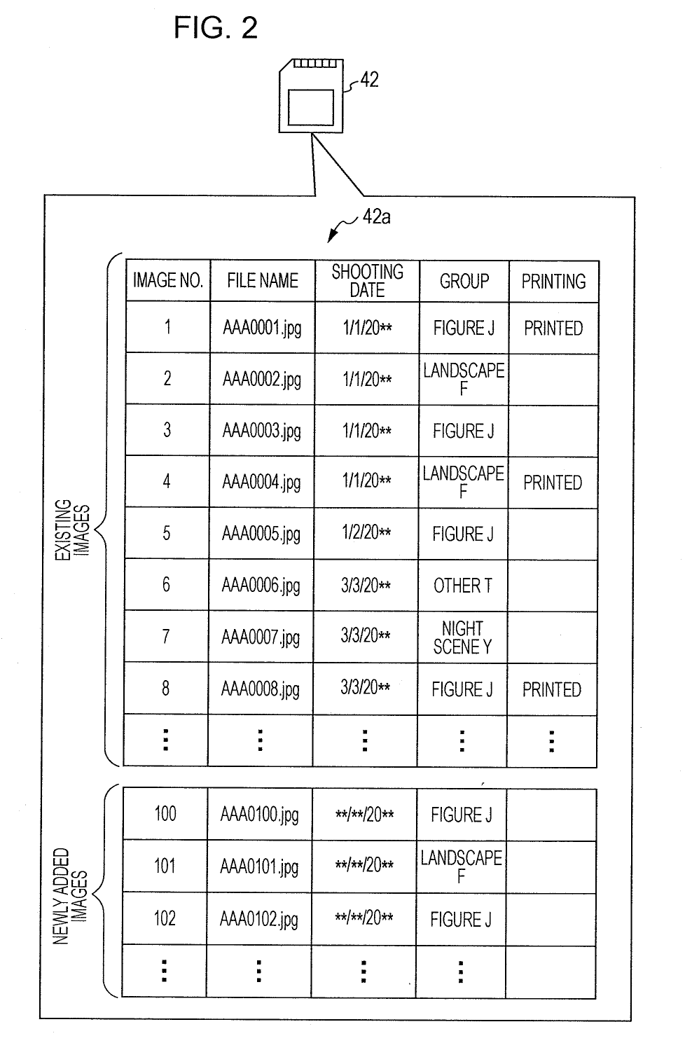

The memory controller 44 performs data input/output to/from the memory card 42 mounted in the memory card slot 40. The memory controller 44 reads data stored in the memory card 42, and transmits the data to the main controller 60 or writes data into the memory card 42 based on an instruction from the main controller 60. The memory card 42 stores a plurality of image files picked up by a digital camera and an image list in which the image files are listed. The image file includes Exif-attached information such as image data which is compressed in a predetermined format (for example, a JPEG format) or thumbnail image data, the number of pixels or the shooting date and time, a diaphragm value, a shooting mode. In the shooting mode of the Exif-attached information, from among a plurality of shooting modes such as a figure shooting mode used when a figure is shot, a landscape shooting mode used when a landscape is shot and a night scene shooting mode used when a night view is shot, the shooting mode selected by a user when an image is shot is recorded. Further, the image list is generated as needed or updated by the main controller 60 when the memory card 42 is mounted in the memory card slot 40 or when list update processing, which will be described later, is performed after image printing processing. FIG. 2 illustrates an example of an image list 42a. As illustrated in FIG. 2, an image number and a file name which are given in a shooting order, a shooting date, and an image group are registered, and for an image in which printing has been performed, “printed” is registered. The image group is acquired according to a shooting mode of the Exif-attached information. A figure group J is registered for an image of the figure shooting mode, a landscape group F is registered for an image of the landscape shooting mode, and a night scene group Y is registered for an image of the night scene shooting mode. For images of the other shooting modes, a further group T is registered. Further, in the image list 42a, newly added images which were shot after the most recent list update and stored in the memory card 42 are registered separately from the existing images which were already registered prior to the most recent list update, and the reason will be described later.

The operation panel 50 includes the display unit 52 and the button set 54. The display unit 52 is a liquid crystal display and displays various operation screens in which menu selection or setting is performed. The button set 54 includes a power button 54a for turning on or off electric power, a start button 54b for instructing printing, a setting button 54c for adjusting various settings such as setting a paper size or decoration for affixing a frame or a decoration to an image, a +− button 54d for increasing or decreasing the number of printing copies, a mode selecting button 54e for selecting various modes, up and down and left and right arrow keys 54f for selecting various items, an OK button 54g for validating a selected setting, a back button 54h for canceling a selected item or returning to the previous screen. The button set 54 is configured to be able to input a user instruction to the main controller 60 through an internal communication interface 69. A mode selected by the mode selecting button 54e includes a normal printing mode in which an image stored in the memory card 42 is printed by selection of a user and an index printing mode in which an index image in which a plurality of thumbnail images is disposed is printed without being selected by a user for the purpose of image retrieval by a user.

The main controller 60 is configured by a microprocessor based on a CPU 62 and includes a ROM 64 in which various processing programs are stored, a RAM 66 in which data is temporarily stored, a flash memory 68 which can be electrically rewritten and stores data even though electric power is turned off, and the internal communication interface 69 which supports communications with the operation panel 50, which are connected to exchange a signal with each other through the bus 12. The main controller 60 receives various operation signals or various detection signals from the printer unit 20 or the memory card controller 44 or receives an operation signal which is generated by an operation of the button set 54 of the operation panel 50. The main controller 60 outputs an instruction for reading out an image file from the memory card 42 and outputting the image file to the main controller 60 to the memory card controller 44, outputs an instruction for performing printing to the printer unit 20, or outputs a control instruction of the display unit 52 to the operation panel 50.

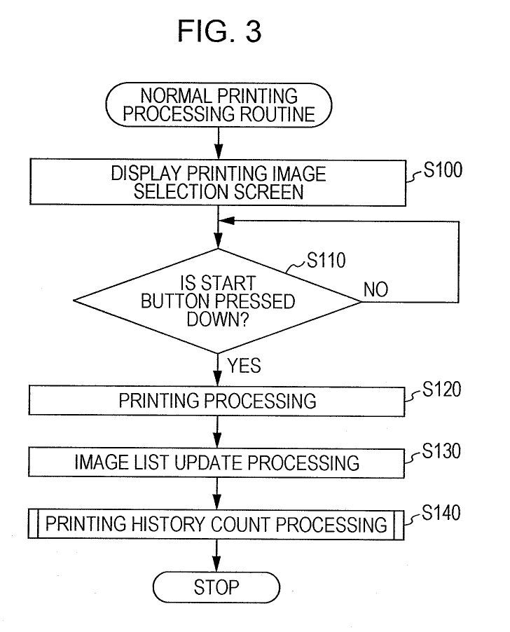

Next, an operation of the photo printer 10 of the present embodiment configured as described above, particularly, a printing operation in a normal printing mode or a printing operation in an index printing mode, will be described. First, an operation at the time of normal printing will be described. FIG. 3 is a flowchart illustrating an example of a normal printing processing routine performed by the main controller 60.

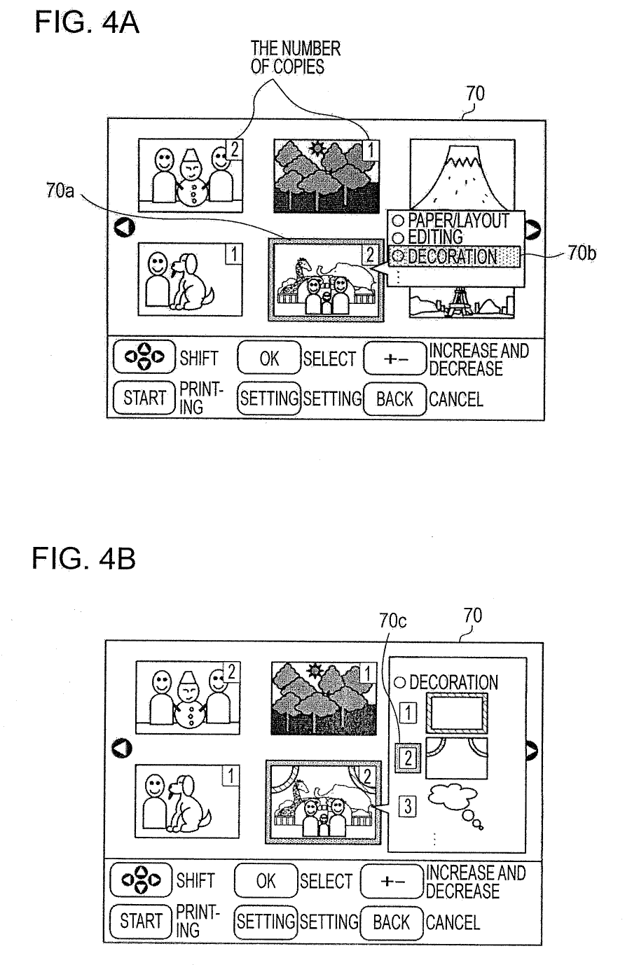

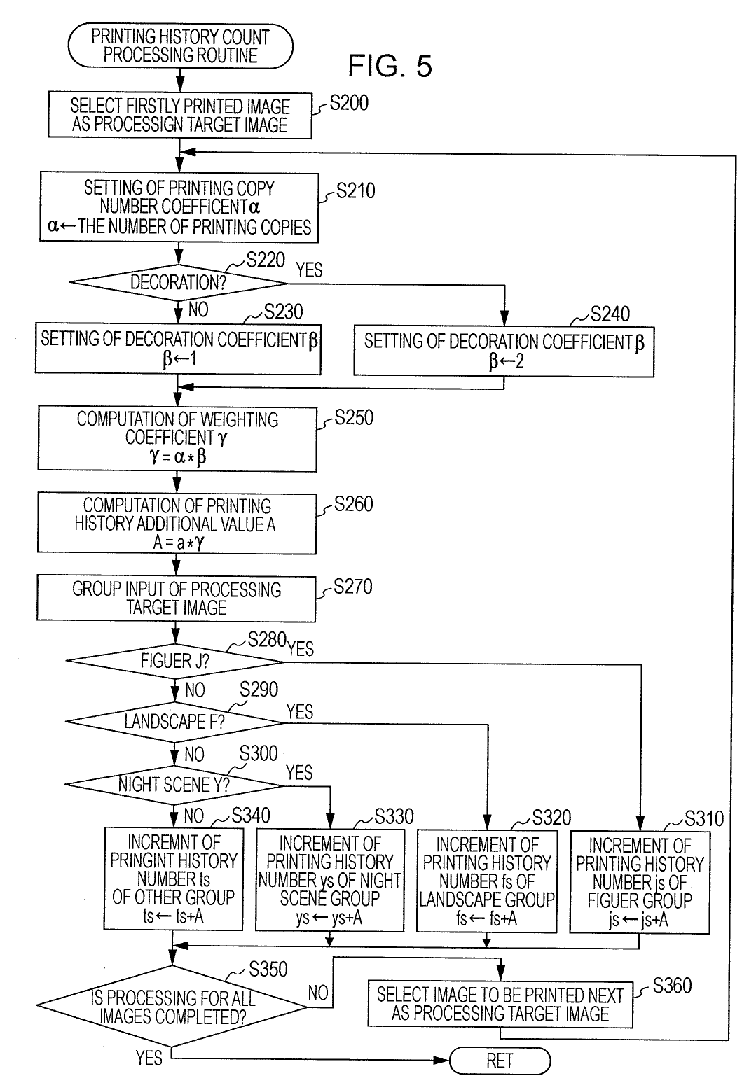

When a normal printing processing routine is executed, the CPU 62 of the main controller 60 displays a printing image selection screen 70 on the display unit 52 (step S100) and waits for an printing image to be selected and the start button 54b to be pressed down (step S110). An example of the printing image selection screen 70 is illustrated in FIGS. 4A and 4B. As illustrated in FIG. 4A, images stored in the memory card 42 are displayed to be selectable. When a cursor 70a is located at a desired image by operation of the arrow keys 54f and the OK button 54g is pressed down, the image is selected as a printing image. Even though the image is selected, when the back button 54h is pressed down, the selection is canceled. The number of printing copies can be increased or decreased by operation of the +− button 54d, and a number on an upper right corner of each image represents the number of printing copies. Further, when the setting button 54c is operated in a state in which an image is selected, a setting menu is displayed. FIG. 4A illustrates a screen in which the setting button 54c is pressed down in a state in which an image in the lower center is selected. In this state, when a cursor 70b is located at “decoration” by operation of the arrow keys 54f and the OK button 54g is pressed down, settable decorations are listed and displayed as illustrated in FIG. 4B. A desired decoration may be selected by operation of the arrow keys 54f and the OK button 54g. In this manner, a printing image can be selected, and the number of printing copies or decoration can be also set as necessary. Subsequently, when the start button 54b is pressed down, printing processing is performed (step S120). When printing processing is performed, update processing of the image list 42a is performed (step S130). As update processing, processing is executed in which a printed image is set to a printed state, and the contents of a newly added image list are included in an existing image list, and the newly added image list is cleared. When image list update processing is executed, printing history count processing for counting the printing history number of each group is executed (step S140), and then the present routine is finished. Next, printing history count processing will be described. FIG. 5 is a flowchart illustrating an example of a printing history count processing routine executed by the main controller 60.

When the printing history count processing routine is executed, the CPU 62 of the main controller 60 first selects a first printed image as a processing target image (step S200) and sets the number of printing copies of the processing target image as a printing copy number coefficient α (step S210). Next, it is determined whether or not the processing target image has been decorated (step S220). When the processing target image has not been decorated, a decoration coefficient β is set to 1 (step S230), while when the processing target image has been decorated, the decoration coefficient β is set to 2 (step S240). Subsequently, the printing copy number coefficient α is multiplied by the decoration coefficient β to compute a weighting coefficient γ (step S250). A value a*γ in which a reference additional value a (here, a value 1) is multiplied by the weighting coefficient γ is computed as a printing history additional value A (step S260). When the printing history additional value A is computed, a group of the processing target image is input from the image list 42a (step S270), and it is determined whether or not the input group is the figure group J (step S280), the landscape group F (step S290), or the night scene group Y (step S300). When it is determined in step S280 that the input group is the figure group J, a printing history number js of the figure group J increases by the value A (step S310). When it is determined in step S290 that the input group is the landscape group F, a printing history number fs of the landscape group F increases by the value A (step S320). When it is determined in step S300 that the input group is the night scene group Y, a printing history number ys of the night scene group Y increases by the value A (step S330). When the input group does not belong to any group, a printing history number ts of the other group T increases by the value A (step S340). An image which a user considers important such as an image having a large number of printing copies or a decorated image has a large weighting coefficient γ, and thus the printing history additional value A has a large value. That is, the printing history number is a value representing the importance of the printed image. The printing history number of each group is registered in the memory card 42. In this manner, when the printing history number is increased, it is determined whether or not processing for all printing images is completed (step S350). When processing for all printing images is not completed, an image which is to be printed next is selected as a processing target image (step S360), and the routine goes back to step S210. Therefore, the processing described above is repeated, and when the processing for all printing images is completed, the present routine is finished.

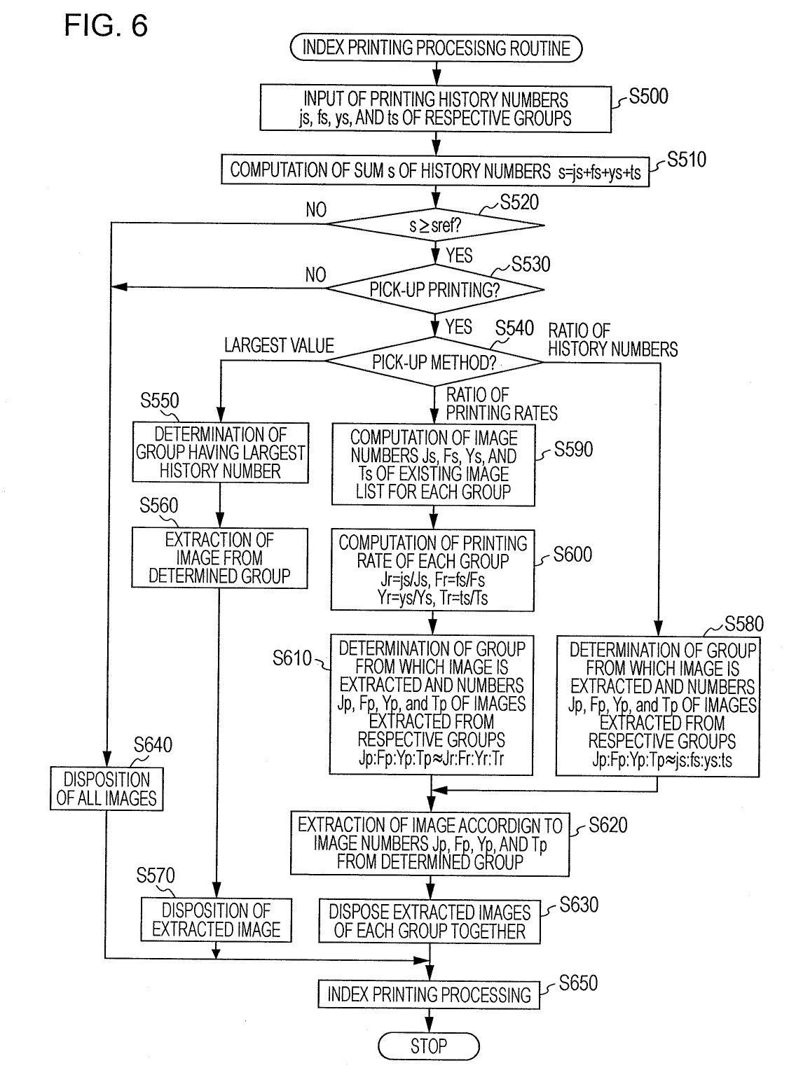

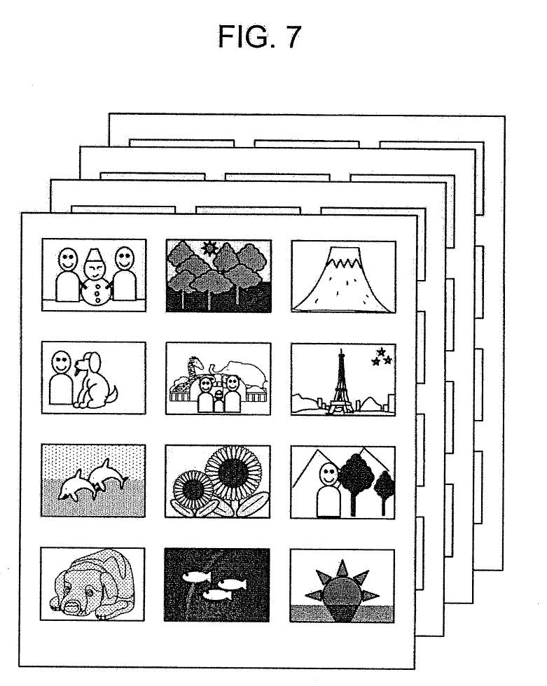

Next, an operation at the time of index printing will be described. FIG. 6 is a flowchart illustrating an example of an index printing processing routine executed by the main controller 60. When this routine is executed, the CPU 62 of the main controller 60 first receives the printing history numbers js, fs, ys, and ts of the respective groups (step S500) and computes a sum s of the input printing history numbers (step S510). Next, it is determined whether or not the computed sum s exceeds a predetermined threshold value sref (step S520). When the sum s exceeds the predetermined threshold value sref, a screen which inquires of a user whether or not to perform pick-up index printing in which images are picked up according to an image selection tendency of a user and index-printed is displayed on the display unit 52 (not illustrated), and a user selection is awaited (step S530). Here, the reason for determining whether or not the sum s exceeds the predetermined threshold value sref is because when a small number of the printing histories are accumulated, it means that an image retrieval performance of a user is not greatly affected and the need for pick-up index printing is not high. For example, a value 10 or a value 20 may be used as the threshold value sref. When the sum s does not exceed the predetermined threshold value sref or when the sum s exceeds the predetermined threshold value sref but a user selects not to perform pick-up index printing, all images in the memory card 42 are disposed in image number order (step S640), index printing processing is performed (step S650), and the present routine is finished. Printing is referred to as normal index printing, and an example of an image printed through this normal index printing is illustrated in FIG. 7. As illustrated in FIG. 7, 4 vertical×3 horizontal thumbnail images are printed on paper P. Since all images are printed, when the number of images is large, the number of printing sheets increases, whereby it becomes difficult to retrieve an image.

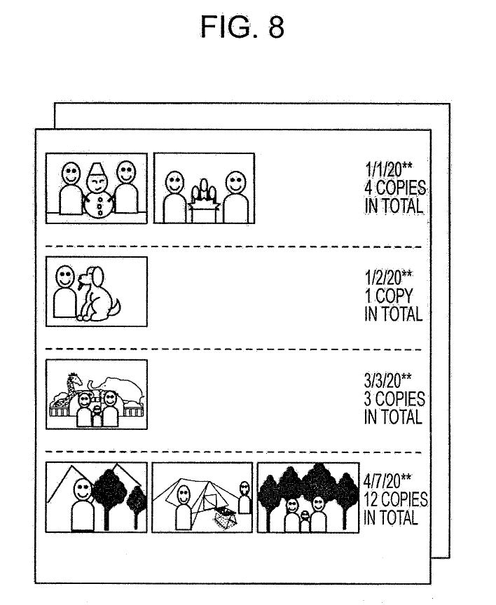

On the other hand, when pick-up index printing is selected in step S530, a pick-up method selection screen which is not illustrated is displayed on the display unit 52, and a user selection is awaited (step S540). The pick-up method is selected as follows. First, when the pick-up method is selected based on a maximum value, it is determined which of the printing history numbers js, fs, ys, and is largest, that is, which group has the largest printing history number is determined (step S550). Next, an image for an index which is to be included in an index image is extracted from the determined group (step S560), and the extracted image is disposed (step S570). In step S650, index printing processing is executed, and the present routine is finished. As a result, an image of a group which has the largest printing history number can be extracted as an image for an index. That is, since an image of a group which a user most frequently prints is extracted as an image for an index, the index image satisfies a user need, whereby the image retrieval performance can be improved. In particular, a user who prints only images of a certain group can easily retrieve such. For example, when the figure group J is largest in printing history number, images of image nos. 1, 3, 5, 8, . . . , 100, and 102 in the image list 42a illustrated in FIG. 2 are extracted as images for an index. At this time, a printed image (an image no. 1 or 8) may be excluded, or a new image (an image no. 100 or 102) may be prioritized. In the former case, since there is a low possibility that an image which is printed once will be printed again, the retrieval performance can be further improved. In the latter case, since there is a high possibility that a new image will be printed compared to an existing image, the retrieval performance can be further improved. An example of an image printed through this pick-up index printing is illustrated in FIG. 8. As illustrated in FIG. 8, images of the figure group J are printed. In FIG. 8, a date represents a shooting date, and a number represents the number of images shot at a corresponding shooting date. FIG. 8 illustrates a case in which a maximum of three images of the figure group J are extracted for each shooting date. For example, four images were shot at Jan. 1, 20XX, and two images of these, which were classified into the figure group J, were printed. Further, images may not necessarily be disposed according to shooting date.

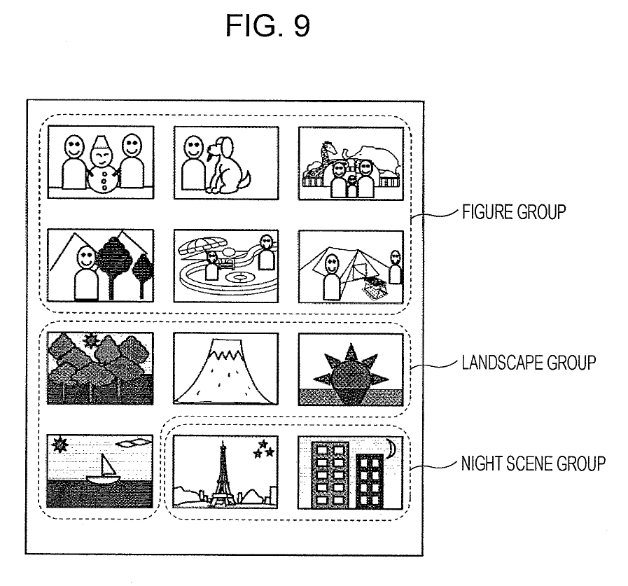

When a pick-up method based on a ratio of history numbers is selected in step S540, a group from which an image for an index is extracted and the numbers Jp, Fp, Yp, and Tp of images extracted from respective groups are determined (step S580). In detail, the image numbers Jp, Fp, Yp, and Tp are determined so that the ratio (Jp:Fp:Yp:Tp) is approximately identical to a ratio (js:fs:ys:ts) of the printing history numbers. For example, let us assume that values of the printing history numbers js, fs, ys, and ts are 9, 5, 3, and 0, respectively, and a total of twelve images for an index are picked up regardless of a shooting date. First, since a value of the printing history number ts of other group T is 0, the remaining groups excluding the other group T are determined as groups from which image are extracted. A ratio of the image numbers Jp, Fp and Yp is determined to be approximately identical to a ratio (js:fs:ys=9:5:3) of the printing history numbers. For example, the ratio (Jp:Fp:Yp) is determined as 6:4:2, and it is determined that six images, four images, and two images (a total of twelve images) are to be extracted from the figure group J, from the landscape group F, and from the night scene group Y, respectively. Next, images are extracted from the determined groups according to the image numbers Jp, Fp, Yp, and Tp (step S620). In this case, an already printed image may be excluded, or a new image may be prioritized. When the images are extracted, the extracted images of each group are disposed together (step S630). Index printing processing is executed in step S650, and the present routine is finished. As a result, since more images are extracted from a group in which more images are printed as images for an index, the index image satisfies a user need, thereby improving the image retrieval performance. An example of an image printed through this pick-up index printing is illustrated in FIG. 9. As illustrated in FIG. 9, images of each group are printed together, and it is easy to retrieve an image. Alternatively, images may be extracted according to a ratio determined according to the shooting date, and the extracted images are disposed to be printed according to the shooting date.

When a pick-up method based on a ratio of printing rates is selected in step S540, the image numbers Js, Fs, Ys, and Ts which are the numbers of images of the respective groups are computed (step S590), and the printing history numbers js, fs, ys, and ts of the respective groups are divided by the image numbers Js, Fs, Ys, and Ts of the respective groups to compute the printing ratios Jr, Fr, Yr, and Tr of the respective groups (step S600). Here, the image number of each group is computed by counting the number of images of each group registered in the existing image list excluding the newly added image list in the image list 42a. When the number of images of a certain group is enormously large, since the printing rate of that particular group may be greatly reduced, the newly added image list is excluded to avoid such a printing rate variation, whereby an image selection tendency of a user can be accurately perceived. When the printing rate is computed in this manner, a group in which an image for an index is extracted and the numbers Jp, Fp, Yp, and Tp of images extracted from the respective groups are determined (step S610). In detail, the image numbers Jp, Fp, Yp, and Tp are determined so that the ratio (Jp:Fp:Yp:Tp) is to be approximately identical to a ratio (Jr:Fr:Yr:Tr) of the printing rates. For example, let us assume that values of the printing history numbers js, fs, ys, and ts are 9, 5, 3, and 0, respectively, values of the image numbers Js, Fs, Ys, and Ts are 20, 10, 4, and 3, respectively, and a total of twelve images for an index are picked up. First, since a value of the printing history number ts of the other group T is 0, the remaining groups excluding the other group T are determined as groups from which images are extracted. Next, a ratio of the image numbers Jp, Fp and Yp is determined to be approximately identical to a ratio of the printing rates (Jr:Fr:Yr=0.45(9/20):0.50(5/10):0.75(3/4)). For example, the ratio (Jp:Fp:Yp) is determined as 3:4:5, and it is determined that three images, four images, and five images (a total of twelve images) are to be extracted from the figure group J, from the landscape group F, and from the night scene group Y, respectively. At this time, it can be understood that the largest number of images are extracted from the night scene group Y which is smallest in printing history number. That is, even though an absolute value of the printing history number is small, more images are extracted from a group which is high in printing rate. When the number of images for an index is determined in this manner, images are extracted in step S620, and the images are disposed in step S630. Index printing processing is executed in step S650, and the present routine is finished. Therefore, since more images are selected from a group which is high in printing rate as images for an index, the index image satisfies a user need, thereby improving the image retrieval performance. Further, since images for an index are disposed together for each group, it is easy to retrieve an image.

Here, the correspondence relationship between components of the present embodiment and components of the invention will be described. The memory card 42 corresponds to a “memory unit”, the main controller 60 which acquires a group of each image from the Exif information of an image corresponds to a “group acquisition unit”, the main controller 60 which executes processing of steps S130 and S140 of the normal printing processing routine of FIG. 3 and processing of the printing history count processing routine of FIG. 5 corresponds to a “history registration unit”, and the main controller 60 which executes processing of steps S500 to S630 and 5650 of the index printing processing routine of FIG. 6 corresponds to a “image forming unit”.

According to the photo printer 10 of the present embodiment described above, since images which have been frequently selected by a user and have a high possibility of being selected by a user are extracted as images for an index, more images are extracted from a group in which more images are selected by a user as images for an index, or more images are extracted from a group which has a high printing rate and high possibility of being selected as images for an index. Therefore, the printing history of the results of user image selection is reflected, and thus an image which meets a user need can be printed in the index image. As a result, the index image can improve the image retrieval performance of a user. Further, since an image which has been already printed and for which there is not a great need is excluded or images of each group are disposed together, the image retrieval performance can be further improved. Furthermore, since images which satisfy an image selection tendency of a user are printed, the number of printing sheets can be reduced.

The invention is not limited to the embodiment described above, and it will be understood that various embodiments can be made within the technical scope of the invention.

In the embodiment described above, an image group is acquired according to a shooting mode, but the invention is not limited to this method. Well-known face recognition processing based on a gradation value of a RGB value of a plurality of pixels sampled from an image may be used to determine scenes of images and classify images into respective groups. Further, the number of image groups is not limited to four, and the number of image groups may be set as necessary to classify the images. For example, the landscape group F may be classified into several groups such as a sea and a mountain, images may be classified into a group in which the shooting time of the Exif information is the daytime, a group in which the shooting time is the evening, and a group in which the shooting time is the night. Images may be classified into a group in which a red tendency is strong, a group in which a green tendency is strong, and a group in which a blue tendency is strong, based on a gradation value of an RGB value of sampled pixels.

In the embodiment described above, an image which is actually printed is counted as the printing history, but the invention is not limited to this. An image which has been selected as a printing image but has been thereafter canceled without being printed may be included in the printing history as a selected image. In detail, an image which has been selected as a printing image by the OK button 54g in the printing image selection screen 70 is included in the printing history as a selected image, and even though the selection has been canceled by the back button 54h after selection, it is not excluded from the printing history. Therefore, since an image which has been selected without being actually printed is included, an image selection tendency of a user can be sufficiently reflected in the index image.

In the embodiment described above, when the sum s of the printing history numbers exceeds the predetermined threshold value sref, pick-up index printing can be selected, but pick-up index printing may be selected regardless of the sum s.

In the embodiment described above, when an image for an index is extracted, a printed image is excluded, but a printed image may not necessarily be excluded. In this case, information about whether or not an image is printed may not be recorded in the image list.

In the embodiment described above, the weighting coefficient γ is computed based on the number of printing copies and the decoration, but the invention is not limited to this. The weighting coefficient γ may be computed based on either of the number of printing copies or the decoration. The weighting coefficient γ may not be computed, and weighting may not be performed.

In the embodiment described above, the index image is printed, but the invention is not limited to this. The index image may be displayed on a display device without being printed. For example, the index image may be displayed as the printing image selection screen 70.

In the present embodiment, an example in which the image forming apparatus of the invention is embodied as a printer having a printing function is illustrated, but the image forming apparatus of the invention may be embodied as a printer having a scanner function or a combined printer such as a facsimile or a copier. The image forming apparatus is not limited to a printer, and the invention may be applied to image processing apparatuses such as personal computers or digital cameras.

What is claimed is:

1. An image forming apparatus which is connected to a memory unit in which a plurality of images is stored, forms an image which is selected by a user from the plurality of images and forms an index image in which a plurality of images which are not selected by the user is disposed, the apparatus comprising:
a group acquisition unit which acquires a group to which the plurality of image belongs from among a plurality of groups into which images are classified;
a history registration unit which associates a formed image with the acquired group to be registered as an image forming history when an image selected by the user is formed; and
an image forming unit which determines a group from which an image used in the index image is extracted, among the plurality of groups, based on the number of formed images of the respective groups which is registered as the image forming history, extracts an image from the determined group, and disposes the extracted images of each of the plurality of groups together to form the index image when instructed to form the index image.

2. The image forming apparatus according to claim 1, wherein the image forming unit is a unit which determines the group which has the largest number of formed images as the group from which the image is extracted.

3. The image forming apparatus according to claim 1, wherein the image forming unit is a unit which extracts an image from the determined group at a ratio which is approximately identical to a ratio of the numbers of formed images of the respective groups.

4. The image forming apparatus according to claim 1, wherein the image forming unit is a unit which extracts an image from the determined group at a rate which is approximately identical to a ratio of image forming rates of the respective groups in which the number of formed images of each group is divided by the number of images of each group.

5. The image forming apparatus according to claim 1, wherein the image forming unit is a unit which extracts an image from the determined group excluding the foamed image.

6. The image forming apparatus according to claim 1, wherein the history registration unit is a unit which registers an image processed by the user when an image is formed by multiplying the number of the formed images by a weighting coefficient of more than 1.

7. The image forming apparatus according to claim 1, further comprising an image classification unit which classifies the plurality of images into the plurality of groups,
wherein the group acquisition unit is a unit which acquires an image classification result from the image classification unit.

8. A program for operating a computer as the image forming apparatus according to claim 1.
